(19) United States
(12) Patent Application Publication
(10) Pub. No.: US 2026/0312992 A1
(43) Pub. Date: Oct. 8, 2026

(54) MANAGING DATA TRANSMISSION USING TRANSPORT LAYER SECURITY FINGERPRINTS AND TCP/IP ADDRESSES

(71) Applicant: International Business Machines Corporation, Armonk, NY (US)

(72) Inventors: Mauro Marzorati, Lutz, FL (US); Behnam Manavi Tehrani, Fort Collins, CO (US); Christopher A. Kulakowski, Austin, TX (US)

(21) Appl. No.: 19/170,604

(22) Filed: Apr. 4, 2025

(51) Int. Cl. H04L 9/40

(52) U.S. Cl. CPC H04L 63/166; H04L 63/1458

(57) ABSTRACT

A computer-implemented method is provided. A processor set receives traffic packets comprising TCP/IP packets from a number of sources. The processor set determines whether transmission for the number of traffic packets exceeds a pre-defined data transmission rate. In response to determining that the transmission for the number of traffic packets exceeds the pre-defined data transmission rate, the processor set collects information associated with the number of traffic packets. The processor set analyzes the transport layer security (TLS) fingerprint associated with the number of traffic packets to determine whether a combination of the TLS fingerprint and the TCP/IP address for the number of traffic packets is associated with known issues. In response to determining that the combination of the TLS fingerprint and the TCP/IP address for the number of traffic packets is associated with known issues, the processor set blocks data transmission for the number of traffic packets.

### BACKGROUND

The disclosure relates generally to managing data transmission using transport layer security (TLS) fingerprints and transmission control protocol/internet protocol (TCP/IP) addresses.

A network analysis technique is a method used to monitor, inspect, and evaluate network traffic to improve performance, enhance security, and optimize data transmission. Network analysis can be performed at various levels, ranging from basic traffic monitoring to deep packet inspection and behavioral analytics. In this case, some techniques focus on packet-level inspection, analyzing individual data packets for security threats, while some other techniques focus on examining traffic patterns and usage statistics to detect anomalies or optimize network resources.

For example, deep packet inspection (DPI) is an advanced network analysis technique that examines the contents of data packets beyond just their headers. Unlike basic packet filtering, which only looks at source and destination information, DPI allows for detailed traffic inspection, identifying specific applications, protocols, and potential security threats within the data payload.

DPI is commonly used for network security, traffic management, and policy enforcement. It can be used for detecting malicious activities, unauthorized access, and compliance violations by analyzing the data being transmitted.

### SUMMARY

According to one illustrative embodiment, a computer-implemented method is provided. A processor set receives a number of traffic packets comprising TCP/IP packets from a number of sources. The processor set determines whether transmission for the number of traffic packets exceeds a pre-defined data transmission rate. In response to determining that the transmission for the number of traffic packets exceeds the pre-defined data transmission rate, the processor set collects information associated with the number of traffic packets. The processor set analyzes a transport layer security (TLS) fingerprint associated with the number of traffic packets to determine whether combination of the transport layer security (TLS) fingerprint and TCP/IP address for the number of traffic packets is associated with a number of known issues. In response to determining that the combination of the transport layer security (TLS) fingerprint and the TCP/IP address for the number of traffic packets is associated with a number of known issues, the processor set blocks data transmission for the number of traffic packets. According to other illustrative embodiments, a computer system, and a computer program product are also provided.

### BRIEF DESCRIPTION OF THE DRAWINGS

FIG. 1 is a pictorial representation of a computing environment in which illustrative embodiments may be implemented;

FIG. 2 is an illustration of a block diagram of a data transmission management environment in accordance with an illustrative embodiment;

FIGS. 3A-3C are illustrations of a process for managing data transmission in accordance with an illustrative embodiment;

FIG. 4 is an illustration of a process for recomputing the cardinality metric in accordance with an illustrative embodiment;

FIG. 5 is an illustration of a process for identifying suspicious traffic in accordance with an illustrative embodiment; and

FIG. 6 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

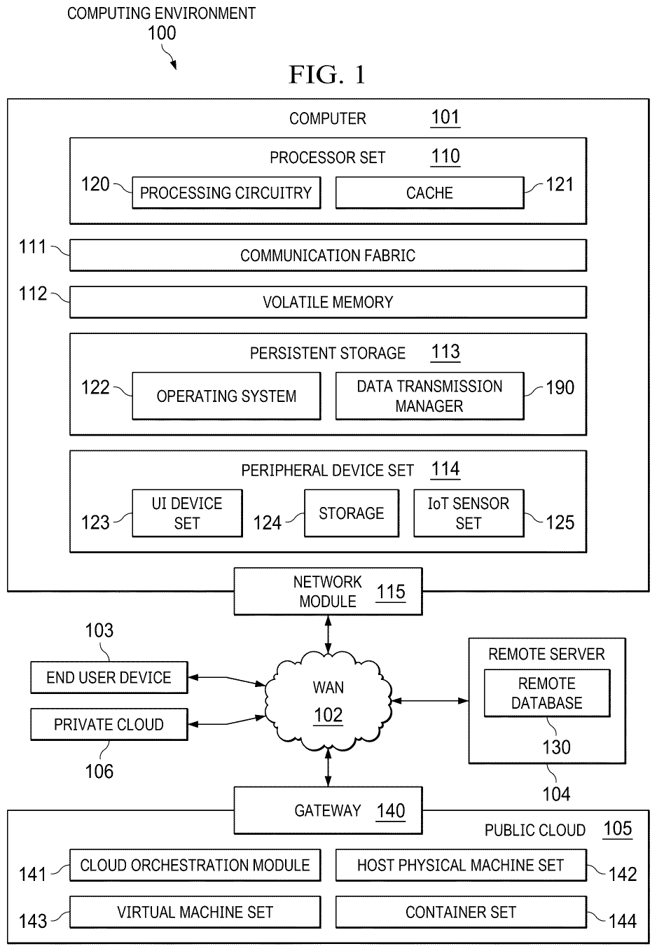

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as data transmission manager 190. In addition to data transmission manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data transmission manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in data transmission manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in data transmission manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that deep packet inspection (DPI) faces limitations when dealing with encrypted traffic such as transport layer security (TLS) protected communications.

The illustrative embodiments recognize and take into account that deep packet inspection is computationally expensive as higher-level application messages that are encapsulated need to be decapsulated and re-encapsulated. This is an important consideration when dealing with flash-traffic/distributed denial-of-service (DDoS) conditions as CPUs can become overwhelmed. For this reason, DDoS rate control mechanisms are typically constrained to act in short bursts based on the barest of information markers.

The illustrative embodiments also recognize and take into account that a “penalty box” (PB) feature is one strategy to reduce the impact of inspecting and denying traffic. The “penalty box” (PB) feature replays the decision to all the traffic sourcing from the same source IP for a timeframe. However, this approach results in potential false positive (FP) denial of service (DoS) of legitimate traffic.

The illustrative embodiments also recognize and take into account that because of internet protocol (IP) address exhaustion, large internet service providers (ISPs) have introduced Carrier-Grade Network Address Translation (CG-NAT), therefore a single IP address now is very likely to mask the traffic of thousands of individuals.

Thus, illustrative embodiments of the present invention provide a computer implemented method, computer system, and computer program product for managing data transmission. A processor set receives a number of traffic packets comprising TCP/IP packets from a number of sources. The processor set determines whether transmission for the number of traffic packets exceeds a pre-defined data transmission rate. In response to determining that the transmission for the number of traffic packets exceeds the pre-defined data transmission rate, the processor set collects information associated with the number of traffic packets. The processor set analyzes the transport layer security (TLS) fingerprint associated with the number of traffic packets to determine whether a combination of the transport layer security (TLS) fingerprint and the TCP/IP address for the number of traffic packets is associated with a number of known issues. In response to determining that the combination of the transport layer security (TLS) fingerprint and the TCP/IP address for the number of traffic packets is associated with a number of known issues, the processor set blocks data transmission for the number of traffic packets.

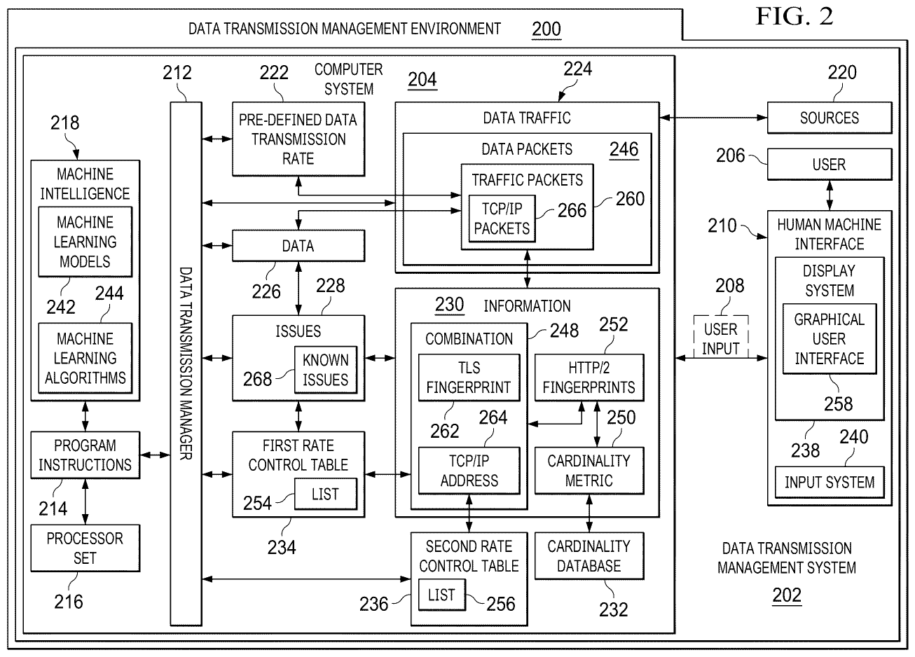

With reference now to FIG. 2, an illustration of a block diagram of a data transmission management environment is depicted in accordance with an illustrative embodiment. In this illustrative example, data transmission management environment 200 includes components that can be implemented in hardware such as the hardware shown in computing environment 100 in FIG. 1.

In this illustrative example, data transmission management system 202 in data transmission management environment 200 can be used to manage data transmission for data traffic 224 that includes data packets 246 from a number of sources 220. In this illustrative example, data traffic 224 is the flow of digital information transmitted over a network. In this example, data traffic 224 includes all types of data exchanged between devices, servers, and applications. In addition, data packets 246 are fundamental units of data traffic 224 that contain information transmitted across the network. In this illustrative example, data is broken down into smaller packets to improve efficiency and reliability when data is sent from one device to another. Data packets 246 typically include three main components that include headers that contain metadata such as source, destination IP addresses, payloads that include actual data transmitted, and footers that include error-checking mechanisms like checksums to ensure data integrity during transmission.

In this illustrative example, data transmission management system 202 includes computer system 204 which includes data transmission manager 212. Data transmission manager 212 is located in computer system 204. Data transmission manager 212 may be implemented using data transmission manager 190 in FIG. 1.

Data transmission manager 212 can be implemented in software, hardware, firmware, or a combination thereof. When software is used, the operations performed by data transmission manager 212 can be implemented in program instructions configured to run on hardware, such as a processor unit. When firmware is used, the operations performed by data transmission manager 212 can be implemented in program instructions and data and stored in persistent memory to run on a processor unit. When hardware is employed, the hardware can include circuits that operate to perform the operations in data transmission manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes machine intelligence 218. Machine intelligence 218 can include machine learning models 242 and machine learning algorithms 244. Machine learning models 242 is a branch of artificial intelligence (AI) that enables computers to detect patterns and improve performance without direct programming commands. Rather than relying on direct input commands to complete a task, machine learning models 242 relies on input data. The data is fed into the machine, one of machine learning algorithms 244 is selected, parameters for the data are configured, and the machine is instructed to find patterns in the input data through optimization algorithms. The data model formed from analyzing the data is then used to predict future values.

Machine intelligence 218 is continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching machine intelligence 218.

Machine intelligence 218 can be implemented using one or more systems such as an artificial intelligence system, a neural network, a generative neural network, a Bayesian network, an expert system, a fuzzy logic system, a genetic algorithm, or other suitable types of systems. Machine learning models 242 and machine learning algorithms 244 may make computer system 204 a special purpose computer for identifying suspicious traffic from data traffic 224.

Machine learning models 242 involves using machine learning algorithms 244 to build computation models based on samples of data. The samples of data used for training are referred to as training data or training datasets. Machine intelligence 218 can make predictions without being explicitly programmed to make these predictions. Machine intelligence 218 can be used for training and retraining computation models for a number of different types of applications. These applications include, for example, medicine, financial services, healthcare, speech recognition, computer vision, or other types of applications.

In this illustrative example, machine learning algorithms 244 can include supervised machine learning algorithms and unsupervised machine learning algorithms. Supervised machine learning can train machine learning models using data containing both the inputs and desired outputs. Examples of machine learning algorithms include XGBoost, K-means clustering, and random forest. In addition, machine learning algorithms 244 can also include semi-supervised learning which necessitates human involvement for input validations.

In this illustrative example, data transmission manager 212 can collect metadata associated with data traffic 224 and identify traffic patterns based on metadata associated with data traffic 224. Traffic patterns for data traffic 224 refers to the characteristics and behaviors of data transmission across the network. In this example, traffic patterns for data traffic 224 describe how data flows between devices and include information associated with timing, volume, direction, and frequency of packet exchanges.

In this illustrative example, data transmission manager 212 can cluster data traffic 224 into groups based on traffic patterns. In this example, data transmission manager 212 can further assign weights to the groups based on the likelihood of encountering malicious behavior. For example, a high weight can be assigned to a group associated with unknown or new traffic patterns and low weight can be assigned to a familiar and verified source.

In this illustrative example, data transmission manager 212 can identify suspicious traffic of data packets from data packets 246 based on groupings for data traffic 224. In this illustrative example, data transmission manager 212 can identify traffic packets 260 from data packets 246 as suspicious traffic. As more data is collected over time, a confidence level can be calculated for each group. In this illustrative example, data collected for data traffic 224 can be used as training data to train machine learning models 242. As a result, data transmission manager 212 can use machine learning models 242 for identifying suspicious traffic from data traffic 224.

In this illustrative example, traffic packets 260 include TCP/IP packets 266. TCP/IP packets 266 are data packets that follow the Transmission Control Protocol/Internet Protocol (TCP/IP) model. Data transmission manager 212 further determines whether transmission for traffic packets 260 exceeds pre-defined data transmission rate 222. Pre-defined data transmission rate 222 is the speed at which data is transferred between devices across the network. In this illustrative example, fluctuations in pre-defined data transmission rate 222 can serve as indicators of potential security threats. For example, a sudden spike in pre-defined data transmission rate 222 may indicate a Distributed Denial-of-Service (DDos) attack, where massive amounts of traffic overwhelm a network or server. In a similar fashion, an unusually high or continuous data transfer rate may suggest data exfiltration, where sensitive information is being stolen from a system.

In this illustrative example, data transmission manager 212 collects information 230 for traffic packets 260. In this illustrative example, information 230 includes transport layer security (TLS) fingerprint 262 and TCP/IP address 264. In this example, transport layer security (TLS) fingerprint 262 is a unique identifier derived from the characteristics of a Transport Layer Security (TLS) handshake, which occurs when a client and server establish a secure connection over a network. During this handshake, the client sends specific parameters, such as supported TLS versions, cipher suites, extensions, and elliptic curves, which can be used to create a fingerprint. These fingerprints help identify specific clients, browsers, or applications, making them useful for security monitoring, bot detection, and threat analysis. In this illustrative example, although transport layer security (TLS) fingerprint 262 is not always unique to an individual user, it can be used for differentiating various software implementations and detect anomalies in network traffic such as data traffic 224.

In addition, TCP/IP address 264 is an address used within the Transmission Control Protocol/Internet Protocol (TCP/IP) model to identify devices on a network. An IP address is a numerical label assigned to each device for sending and receiving data across the internet or local networks. IP addresses can be either IPv4 or IPv6 depending on the network configuration.

The TCP/IP model ensures that data packets are transmitted accurately between devices. The TCP (Transmission Control Protocol) manages data integrity and sequencing, ensuring packets arrive correctly, while the IP (Internet Protocol) handles addressing and routing, ensuring packets reach their intended destination. Together, a TCP/IP address helps facilitate reliable communication across digital networks.

Transport layer security (TLS) fingerprint 262 and TCP/IP address 264 form combination 248, which provides insight into network activity, user identification, and security monitoring. In this illustrative example, data transmission manager 212 can use combination 248 to identify anomalies in data transmission as an unusual combination of IP address and TLS fingerprints is detected. For example, if a well-known TLS fingerprint associated with a common web browser suddenly appears from an unexpected IP range, it could suggest VPN use, potential spoofing, or malicious activity.

As depicted, data transmission manager 212 can analyze transport layer security (TLS) fingerprint 262 and TCP/IP address 264 to determine if combination 248 is associated with a number of known issues 268 from issues 228. In this illustrative example, issues 228 can include network congestion, packet loss, latency and delay, cyberthreats, malicious attacks, bandwidth saturation, or any suitable issues associated with data traffic across the network. In this example, the number of known issues 268 are issues that are previously identified for combination 248. In other words, data transmission manager 212 determines whether transport layer security (TLS) fingerprint 262 and TCP/IP address 264 from combination 248 are previously associated with any issue from the number of known issues 268. As a result, data transmission manager 212 can block data transmission for traffic packets 260 in response to determining that combination 248 was previously associated with any issue from the number of known issues 268.

In this illustrative example, data transmission manager 212 can further measure a cardinality metric 250 for traffic packets 260 when analyzing combination 248. In this example, cardinality metric 250 indicates a number of distinct HTTP/2 fingerprints 252. In this illustrative example, HTTP/2 fingerprints 252 are unique characteristics of a client or server's implementation of the HTTP/2 protocol, which can be used to identify and differentiate users. In this example, HTTP/2 fingerprints 252 can be generated from features such as settings parameters, header behaviors, stream concurrency and timing, or any suitable attributes associated with HTTP/2 connections.

In this illustrative example, cardinality metric 250 that represents a number of distinct HTTP/2 fingerprints 252 can be used to estimate the number of devices or users behind TCP/IP address 264. In other words, a high score of cardinality metric 250 indicates more uncertainty associated with traffic packets 260 because more users or devices are behind TCP/IP address 264, thereby causing more cybersecurity risks.

In this illustrative example, HTTP/2 fingerprints 252 that are used for computing cardinality metric 250 can be coupled with combination 248 for analysis. In this illustrative example, data transmission manager 212 can distinguish legitimate users and malicious data traffic more accurately when considering both combination 248 and HTTP/2 fingerprints 252.

In this illustrative example, cardinality metric 250 can be stored in cardinality database 232 and it is continuously recomputed by data transmission manager 212 over time to reflect the most up-to-date cybersecurity risk associated with data traffic 224. In this illustrative example, the combination of transport layer security (TLS) fingerprint 262, TCP/IP address 264, and HTTP/2 fingerprints 252 can also be stored in cardinality database 232 if data transmission of traffic packets 260 does not exceed pre-defined data transmission rate 222.

On the other hand, if combination 248 is not associated with the number of known issues 268, data transmission manager 212 collects data 226 from traffic packets 260 for further analysis. Data 226 can include information associated with traffic packets 260. For example, data 226 can include protocols such as Simple Object Access Protocol (SOAP) and Hypertext Transfer Protocol (HTTP) and data format such as JavaScript Object Notation (JSON) for traffic packets 260.

In an alternative illustrative example, collection of information associated with traffic packets 260 can be performed as a “resampling” process, where computer system 204 collects additional information associated with data traffic 224 when data traffic behavior for data deviates significantly from the normal condition.

For example, data transmission manager 212 can use a continuous methodology to compute and summarize statistical properties of data such as mean, standard deviation, and variance for data traffic 224. This process can be performed for attributes associated with data traffic 224 such as traffic parameters, packet rate, and IP address frequency. In this illustrative example, data transmission manager 212 can establish a baseline distribution for normal data traffic based on the summarized statistical property of data for data traffic 224.

Subsequently, data transmission manager 212 can calculate other metrics such as Z-scores or Chi-squared tests to detect if traffic packets 260 from data traffic 224 is associated with issues 228 for anomaly detection. In this case, Z-score calculates how far the current traffic parameter deviates from the baseline in terms of standard deviation. For example, a high Z-score indicates unusual activity and triggers “resampling” of information 230 and data 226 for traffic packets 260.

In this illustrative example, data transmission manager 212 will dynamically increase the sampling rate once an anomaly is detected by data transmission manager 212. In this example, the sampling rate can be a function of the severity of the anomaly. For example, if the data traffic is slightly unusual but not highly suspicious, data transmission manager 212 can increase the sampling rate from 10% to 20% of all data traffic. On the other hand, if traffic deviates drastically, data transmission manager 212 will resample a higher percentage or even inspect all data traffic temporarily. In an illustrative example, the sampling rate can be updated using Bayesian Inference as more packets are inspected and classified as benign or malicious, where such information can be used as a reference for data transmission manager 212 to adjust the sampling rate accordingly.

As depicted, data transmission manager 212 can also use machine learning models 242 to group data traffic 224 based on similar characteristics. In this example, data transmission manager 212 can apply different sampling rates based on traffic behavior for different groups. In this illustrative example, machine learning models 242 can cluster data traffic 224 by identifying traffic patterns based on features such as IP Address, TLS Fingerprints, HTTP/2 fingerprints, packet size, and rate of request from IP. This combination of features provides a comprehensive representation of the traffic and its context. In this example, machine learning models 242 can optimize clustering algorithms based on the above-mentioned feature inputs for deployment. For example, machine learning models 242 can optimize clustering algorithms such as k-means, Density-Based Spatial Clustering of Applications with Noise (DBSCAN), and Gaussian Mixture Models (GMM), or any suitable clustering algorithm.

After clustering algorithms have been applied, each traffic instance from data traffic 224 can be assigned to a specific group using machine learning models 242. For example, machine learning models 242 can assign each traffic instance from data traffic 224 to three groups that include a first group with mostly benign traffic where IPs of traffic instances are verified, a second group with potentially suspicious traffic where traffic instances that have high packets rates from unknown IPs, and a third group with highly suspicious traffic where traffic instances include new IPs, or erratic behavior associated with past attacks. As depicted, data transmission manager 212 applies different sampling rates to different groups. For example, data transmission manager 212 can sample 5% of the data traffic for the first group, 20% of the data traffic for the second group, and 50% of the data traffic for the third group.

In addition, machine learning models 242 can further include a classifier that predicts the probability of traffic being malicious or benign. The classifier will be trained based on input features such as IP-Reputation, historical attack data, traffic behavior, and TLS fingerprints. The classifier can be implemented using algorithms such as random forests, XG-Boost, or neural networks. In this illustrative example, the classifier can output a probability score for each incoming traffic instance from data traffic 224. The probability scores can be a value between 0 and 1 that indicates the likelihood of the traffic being malicious or benign. In this illustrative example, data traffic with low probability scores can be sampled less frequently and data traffic with high probability scores can be sampled more frequently.

As depicted, data transmission manager 212 analyzes data 226 to determine whether traffic packets 260 are associated with issues 228. In this illustrative example, data transmission manager 212 blocks transmission for traffic packets 260 if traffic packets 260 are associated with issues 228. In addition, data transmission manager 212 adds combination 248 for traffic packets 260 to first rate control table 234 for future reference. In this example, first rate control table 234 includes list 254, which contains a list of combinations of transport layer security (TLS) fingerprints and the TCP/IP addresses that are related to issues 228. In other words, first rate control table 234 and list 254 serve as a blocklist for data transmission manager 212 such that data transmission manager 212 can efficiently identify cyberthreats in the future.

In contrast, data transmission manager 212 fulfills transmission for traffic packets 260 if traffic packets 260 are not associated with issues 228. In this illustrative example, data transmission manager 212 adds combination 248 for traffic packets 260 to second rate control table 236 for future reference. In this example, second rate control table 236 includes list 256, which contains a list of combinations of transport layer security (TLS) fingerprints and the TCP/IP addresses that are not related to issues 228. In other words, second rate control table 236 and list 256 serve as an allowlist for data transmission manager 212 such that data transmission manager 212 can efficiently identify benign data traffic.

In this illustrative example, user 206 can interact with computer system 204 via user input 208. User input 208 can be generated by user 206 using human machine interface (HMI) 210. For example, user 206 can define pre-defined data transmission rate 222 through user input 208. As depicted, human machine interface 210 includes display system 238 and input system 240. Display system 238 is a physical hardware system and includes one or more display devices on which graphical user interface 258 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, virtual reality headsets, or some other suitable device that can output information for the visual presentation of information.

In this example, user 206 is a person that can interact with graphical user interface 258 through user input 208 generated by input system 240. Input system 240 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. In this illustrative example, user 206 can view cardinality metric 250, first rate control table 234, list 254, second rate control table 236, and list 256 through graphical user interface 258.

As a result, data transmission manager 212 can efficiently identify malicious cyberthreats and block data transmission when threats are identified using methods described above.

In one illustrative example, one or more solutions are present that overcome a problem with identifying malicious cyberthreats. As a result, one or more technical solutions may provide an ability to increase the efficiency for identifying malicious cyberthreats. In this illustrative example, improvement on efficiency of identifying malicious cyberthreats directly contributes to improved computer functioning by optimizing system responsiveness, reducing resource consumption, and minimizing downtime. A computer system can avoid redundant computations or unnecessary traversals through data when computer functioning is free of cyberthreats. This improvement in efficiency translates into reduced overhead of executed processes. In addition, hardware functioning can also benefit from efficient identification of malicious cyberthreats through reduced wear on storage devices, lower power consumption, and better utilization of hardware resources.

In addition, the dynamic resampling process using machine learning models 242 can enhance network monitoring, security analytics, and application performance management. Traditional static sampling methods may either collect too much data, overwhelming storage and processing resources, or too little data, missing crucial insights. By dynamically adjusting sampling rates in real time, data transmission manager 212 can focus on high-priority traffic, such as unusual patterns that might indicate cyberthreats or network anomalies.

Further, dynamically changing data traffic sampling improves the efficiency of network devices, security appliances, and embedded systems. Hardware components such as routers, firewalls, and network switches process vast amounts of data in real time. In this illustrative example, static sampling can either strain hardware resources by collecting unnecessary data or fail to capture key traffic patterns. By adapting sampling rates based on user defined criteria, hardware devices can optimize processing power and memory usage while ensuring high-priority data is analyzed effectively.

In the illustrative example, computer system 204 can be configured to perform at least one of the steps, operations, or actions described in the different illustrative examples using software, hardware, firmware, or a combination thereof. As a result, computer system 204 operates as a special purpose computer system in which data transmission manager 212 in computer system 204 enables identification of malicious cyberthreats in a quick and efficient manner. In particular, data transmission manager 212 transforms computer system 204 into a special purpose computer system as compared to currently available general computer systems that do not have data transmission manager 212.

The illustration of data transmission management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

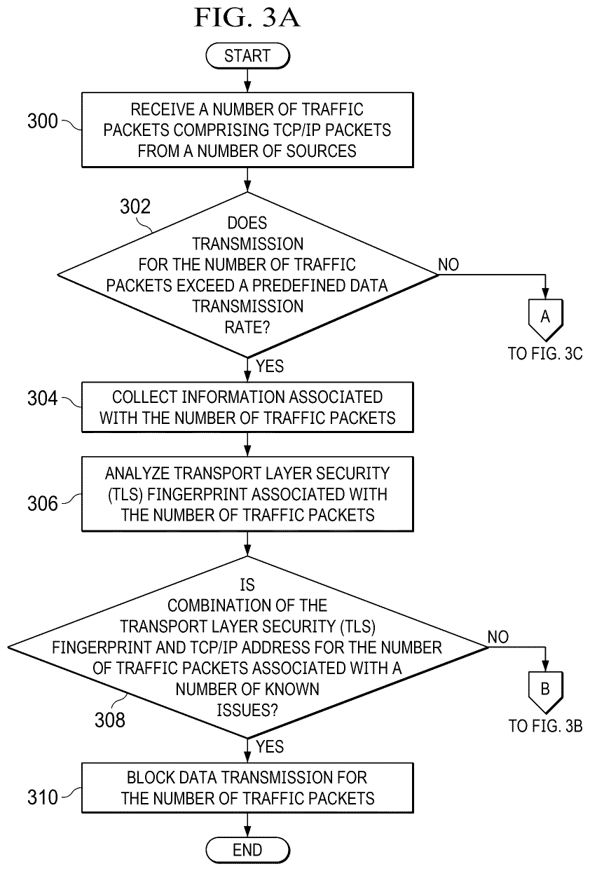

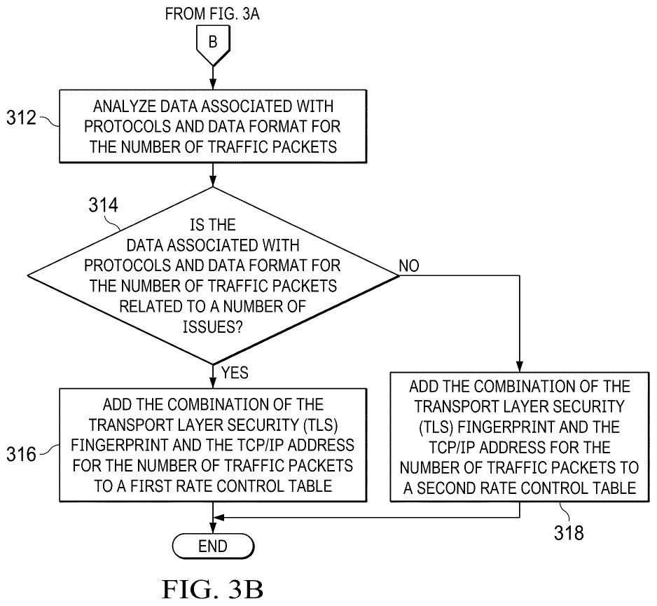

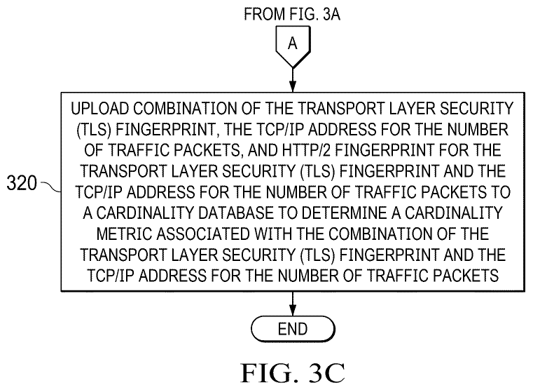

With reference now to FIGS. 3A-3C, a flowchart illustrating a process for managing data transmission is shown in accordance with an illustrative embodiment. The process in FIGS. 3A-3C can be implemented in hardware, software, or both. When implemented in software, the process can take the form of program instructions that are run by one of more processor units located in one or more hardware devices in one or more computer systems. For example, the process can be implemented in data transmission manager 212 in computer system 204 in FIG. 2.

The process begins by receiving a number of traffic packets comprising TCP/IP packets from a number of sources (step 300). The process determines whether transmission for the number of traffic packets exceeds a pre-defined data transmission rate (step 302). If the transmission for the number of traffic packets exceeds a pre-defined data transmission rate, the process collects information associated with the number of traffic packets (step 304).

The process analyzes transport layer security (TLS) fingerprint associated with the number of traffic packets (step 306). The process determines whether a combination of the transport layer security (TLS) fingerprint and TCP/IP address for the number of traffic packets is associated with a number of known issues (step 308). If the combination of the transport layer security (TLS) fingerprint and TCP/IP address for the number of traffic packets is associated with a number of known issues, the process blocks data transmission for the number of traffic packets (step 310). The process terminates thereafter.

With reference again to step 308, if a combination of the transport layer security (TLS) fingerprint and TCP/IP address for the number of traffic packets is not associated with a number of known issues, the process analyzes data associated with protocols and data format for the number of traffic packets (step 312). The process determines whether the data associated with protocols and data format for the number of traffic packets is related to a number of issues (step 314).

If the data associated with protocols and data format for the number of traffic packets is related to a number of issues, the process adds the combination of the transport layer security (TLS) fingerprint and the TCP/IP address for the number of traffic packets to a first rate control table (step 316). In step 316, the first rate control table comprises a list of combinations of transport layer security (TLS) fingerprint and the TCP/IP address that are related to the number of issues. The process terminates thereafter. With reference again to step 314, if the data associated with protocols and data format for the number of traffic packets is not related to a number of issues, the process adds the combination of the transport layer security (TLS) fingerprint and the TCP/IP address for the number of traffic packets to a second rate control table (step 318). In step 318, the second rate control table comprises a list of combinations of transport layer security (TLS) fingerprint and TCP address that are not related to the number of issues. The process terminates thereafter.

With reference again to step 302, if the transmission for the number of traffic packets does not exceed a pre-defined data transmission rate, the process uploads combination of the transport layer security (TLS) fingerprint, the TCP/IP address for the number of traffic packets, and HTTP/2 fingerprint for the transport layer security (TLS) fingerprint and the TCP/IP address for the number of traffic packets to a cardinality database to determine a cardinality metric associated with the combination of the transport layer security (TLS) fingerprint and the TCP/IP address for the number of traffic packets (step 320). The process terminates thereafter.

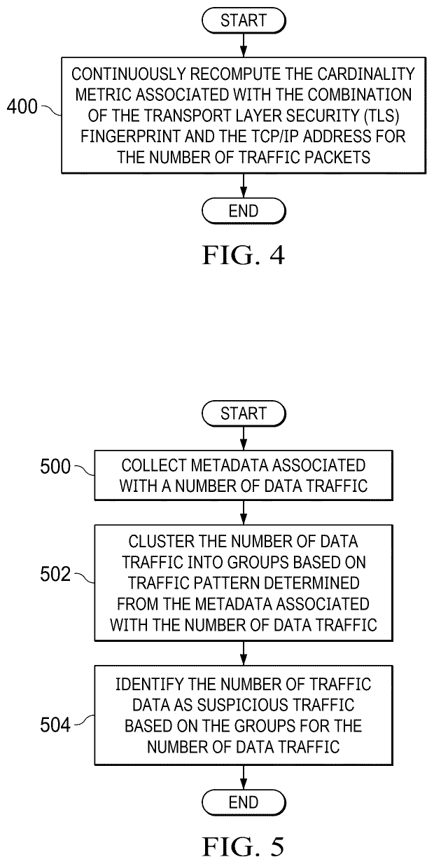

Turning next to FIG. 4, a flowchart of a process for recomputing the cardinality metric is depicted in accordance with an illustrative embodiment. The process in this figure is an example of an additional step that can be performed with the steps in FIGS. 3A-3C.

The process begins by continuously recomputing the cardinality metric associated with the combination of the transport layer security (TLS) fingerprint and the TCP/IP address for the number of traffic packets. (step 400). The process terminates thereafter.

Turning next to FIG. 5, a flowchart of a process for identifying suspicious traffic is depicted in accordance with an illustrative embodiment. The process in this figure is an example of an additional step that can be performed with the steps in FIGS. 3A-3C.

The process begins by collecting metadata associated with a number of data traffic (step 500). The process clusters the number of data traffic into groups based on traffic pattern determined from the metadata associated with the number of data traffic (step 502). The process identifies the number of traffic data as suspicious traffic based on the groups for the number of data traffic (step 504). The process terminates thereafter.

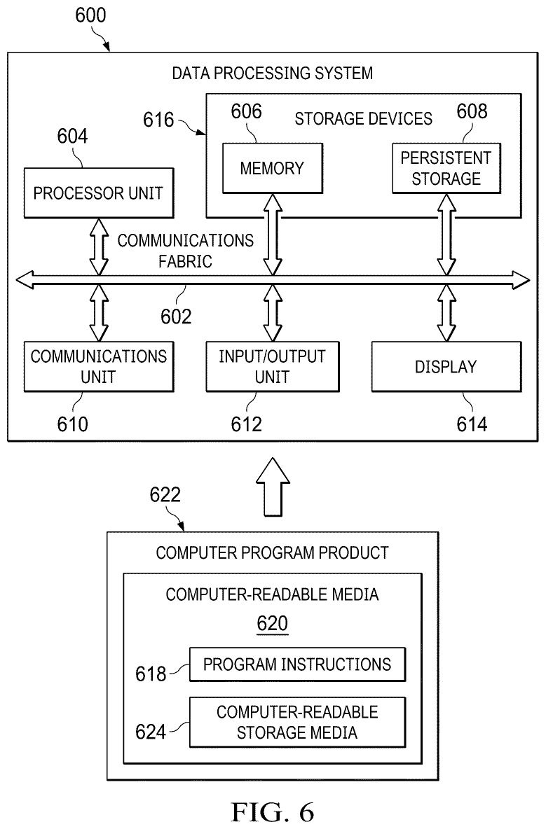

Turning now to FIG. 6, a block diagram of a data processing system is depicted in accordance with an illustrative embodiment. Data processing system 600 can be used to implement computers and computing devices in computing environment 100 in FIG. 1. Data processing system 600 can also be used to implement computer system 204 in FIG. 2. In this illustrative example, data processing system 600 includes communications framework 602, which provides communications between processor unit 604, memory 606, persistent storage 608, communications unit 610, input/output (I/O) unit 612, and display 614. In this example, communications framework 602 takes the form of a bus system.

Processor unit 604 serves to execute instructions for software that can be loaded into memory 606. Processor unit 604 includes one or more processors. For example, processor unit 604 can be selected from at least one of a multicore processor, a central processing unit (CPU), a graphics processing unit (GPU), a physics processing unit (PPU), a digital signal processor (DSP), a network processor, or some other suitable type of processor. Further, processor unit 604 can be implemented using one or more heterogeneous processor systems in which a main processor is present with secondary processors on a single chip. As another illustrative example, processor unit 604 can be a symmetric multi-processor system containing multiple processors of the same type on a single chip.

Memory 606 and persistent storage 608 are examples of storage devices 616. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 616 may also be referred to as computer-readable storage devices in these illustrative examples. Memory 606, in these examples, can be, for example, a random-access memory or any other suitable volatile or non-volatile storage device. Persistent storage 608 may take various forms, depending on the particular implementation.

For example, persistent storage 608 may contain one or more components or devices. For example, persistent storage 608 can be a hard drive, a solid-state drive (SSD), a flash memory, a rewritable optical disk, a rewritable magnetic tape, or some combination of the above. The media used by persistent storage 608 also can be removable. For example, a removable hard drive can be used for persistent storage 608.

Communications unit 610, in these illustrative examples, provides for communications with other data processing systems or devices. In these illustrative examples, communications unit 610 is a network interface card.

Input/output unit 612 allows for input and output of data with other devices that can be connected to data processing system 600. For example, input/output unit 612 may provide a connection for user input through at least one of a keyboard, a mouse, or some other suitable input device. Further, input/output unit 612 may send output to a printer. Display 614 provides a mechanism to display information to a user.

Instructions for at least one of the operating system, applications, or programs can be located in storage devices 616, which are in communication with processor unit 604 through communications framework 602. The processes of the different embodiments can be performed by processor unit 604 using computer-implemented instructions, which may be located in a memory, such as memory 606.

These instructions are referred to as program instructions, computer usable program instructions, or computer-readable program instructions that can be read and executed by a processor in processor unit 604. The program instructions in the different embodiments can be embodied on different physical or computer-readable storage media, such as memory 606 or persistent storage 608.

Program instructions 618 are located in a functional form on computer-readable media 620 that is selectively removable and can be loaded onto or transferred to data processing system 600 for execution by processor unit 604. Program instructions 618 and computer-readable media 620 form computer program product 622 in these illustrative examples. In the illustrative example, computer-readable media 620 is computer-readable storage media 624.

Computer-readable storage media 624 is a physical or tangible storage device used to store program instructions 618 rather than a medium that propagates or transmits program instructions 618. Computer-readable storage media 624, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 618 can be transferred to data processing system 600 using a computer-readable signal media. The computer-readable signal media are signals and can be, for example, a propagated data signal containing program instructions 618. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 620” can be singular or plural. For example, program instructions 618 can be located in computer-readable media 620 in the form of a single storage device or system. In another example, program instructions 618 can be located in computer-readable media 620 that is distributed in multiple data processing systems. In other words, some instructions in program instructions 618 can be located in one data processing system while other instructions in program instructions 618 can be located in one data processing system. For example, a portion of program instructions 618 can be located in computer-readable media 620 in a server computer while another portion of program instructions 618 can be located in computer-readable media 620 located in a set of client computers.

The different components illustrated for data processing system 600 are not meant to provide architectural limitations to the manner in which different embodiments can be implemented. In some illustrative examples, one or more of the components may be incorporated in or otherwise form a portion of another component. For example, memory 606, or portions thereof, may be incorporated in processor unit 604 in some illustrative examples. The different illustrative embodiments can be implemented in a data processing system including components in addition to or in place of those illustrated for data processing system 600. Other components shown in FIG. 6 can be varied from the illustrative examples shown. The different embodiments can be implemented using any hardware device or system capable of running program instructions 618.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method comprising:
receiving, by a processor set, a number of traffic packets comprising TCP/IP packets from a number of sources;
determining, by the processor set, whether transmission for the number of traffic packets exceeds a pre-defined data transmission rate;
in response to determining that the transmission for the number of traffic packets exceeds the pre-defined data transmission rate, collecting, by the processor set, information associated with the number of traffic packets;
analyzing, by the processor set, a transport layer security (TLS) fingerprint associated with the number of traffic packets to determine whether combination of the transport layer security (TLS) fingerprint and TCP/IP address for the number of traffic packets is associated with a number of known issues; and
in response to determining that the combination of the transport layer security (TLS) fingerprint and the TCP/IP address for the number of traffic packets is associated with a number of known issues, blocking, by the processor set, data transmission for the number of traffic packets.

2. The computer implemented method of claim 1, further comprising:
in response to determining that the combination of the transport layer security (TLS) address and the TCP/IP address for the number of traffic packets is not associated with a number of known issues, analyzing, by the processor set, data associated with protocols and data format for the number of traffic packets;
determining, by the processor set, whether the data associated with protocols and data format for the number of traffic packets is related to a number of issues; and
in response to determining that the data associated with protocols and data format for the number of traffic packets is related to a number of issues, adding, by the processor set, the combination of the transport layer security (TLS) fingerprint and the TCP/IP address for the number of traffic packets to a first rate control table, wherein the first rate control table comprises a list of combinations of transport layer security (TLS) fingerprint and the TCP/IP address that are related to the number of issues.

3. The computer implemented method of claim 2, further comprising:
in response to determining that the data associated with protocols and data format for the number of traffic packets is not related to a number of issues, adding, by the processor set, the combination of the transport layer security (TLS) fingerprint and the TCP/IP address for the number of traffic packets to a second rate control table, wherein the second rate control table comprises a list of combinations of transport layer security (TLS) fingerprint and TCP address that are not related to the number of issues.

4. The computer implemented method of claim 1, wherein the information associated with the number of traffic packets comprises a cardinality metric for the combination of the transport layer security (TLS) fingerprint and the TCP/IP address, wherein the cardinality metric indicates a number of distinct HTTP/2 fingerprints.

5. The computer implemented method of claim 1, further comprising:
in response to determining that the number of traffic packets does not exceed the pre-defined data transmission rate, uploading, by the processor set, combination of the transport layer security (TLS) fingerprint, the TCP/IP address for the number of traffic packets, and HTTP/2 fingerprint for the transport layer security (TLS) fingerprint and the TCP/IP address for the number of traffic packets to a cardinality database to determine a cardinality metric associated with the combination of the transport layer security (TLS) fingerprint and the TCP/IP address for the number of traffic packets.

6. The computer implemented method of claim 5, further comprising:
continuously recomputing, by the processor set, the cardinality metric associated with the combination of the transport layer security (TLS) fingerprint and the TCP/IP address for the number of traffic packets.

7. The computer implemented method of claim 1, further comprises:
collecting, by the processor set, metadata associated with a number of data traffic, wherein each data traffic from the number of data traffic comprises a number of data packets transmitted over a network;
clustering, by the processor set, the number of data traffic into groups based on traffic pattern determined from the metadata associated with the number of data traffic; and
identifying, by the processor set, the number of traffic data as suspicious traffic based on the groups for the number of data traffic.

8. A computer system comprising:
a processor set;
a set of one or more computer-readable storage media; and
program instructions stored on the set of one or more storage media to cause the processor set to perform operations comprising:
receiving a number of traffic packets comprising TCP/IP packets from a number of sources;
determining whether transmission for the number of traffic packets exceeds a pre-defined data transmission rate;
in response to determining that the transmission for the number of traffic packets exceeds the pre-defined data transmission rate, collecting information associated with the number of traffic packets;
analyzing a transport layer security (TLS) fingerprint associated with the number of traffic packets to determine whether combination of the transport layer security (TLS) fingerprint and TCP/IP address for the number of traffic packets is associated with a number of known issues; and
in response to determining that the combination of the transport layer security (TLS) fingerprint and the TCP/IP address for the number of traffic packets is associated with a number of known issues, blocking data transmission for the number of traffic packets.

9. The computer system of claim 8, wherein the operations further comprising:
in response to determining that the combination of the transport layer security (TLS) address and the TCP/IP address for the number of traffic packets is not associated with a number of known issues, analyzing data associated with protocols and data format for the number of traffic packets;
determining whether the data associated with protocols and data format for the number of traffic packets is related to a number of issues; and
in response to determining that the data associated with protocols and data format for the number of traffic packets is related to a number of issues, adding the combination of the transport layer security (TLS) fingerprint and the TCP/IP address for the number of traffic packets to a first rate control table, wherein the first rate control table comprises a list of combinations of transport layer security (TLS) fingerprint and the TCP/IP address that are related to the number of issues.

10. The computer system of claim 9, wherein the operations further comprising:
in response to determining that the data associated with protocols and data format for the number of traffic packets is not related to a number of issues, adding the combination of the transport layer security (TLS) fingerprint and the TCP/IP address for the number of traffic packets to a second rate control table, wherein the second rate control table comprises a list of combinations of transport layer security (TLS) fingerprint and TCP address that are not related to the number of issues.

11. The computer system of claim 8, wherein the information associated with the number of traffic packets comprises a cardinality metric for the combination of the transport layer security (TLS) fingerprint and the TCP/IP address, wherein the cardinality metric indicates a number of distinct HTTP/2 fingerprints.

12. The computer system of claim 8, wherein the operations further comprising:
in response to determining that the number of traffic packets does not exceed the pre-defined data transmission rate, uploading combination of the transport layer security (TLS) fingerprint, the TCP/IP address for the number of traffic packets, and HTTP/2 fingerprint for the transport layer security (TLS) fingerprint and the TCP/IP address for the number of traffic packets to a cardinality database to determine a cardinality metric associated with the combination of the transport layer security (TLS) fingerprint and the TCP/IP address for the number of traffic packets.

13. The computer system of claim 12, wherein the operations further comprising:
continuously recomputing the cardinality metric associated with the combination of the transport layer security (TLS) fingerprint and the TCP/IP address for the number of traffic packets.

14. The computer system of claim 8, wherein the operations further comprising:
collecting metadata associated with a number of data traffic, wherein each data traffic from the number of data traffic comprises a number of data packets transmitted over a network;
clustering the number of data traffic into groups based on traffic pattern determined from the metadata associated with the number of data traffic; and
identifying the number of traffic data as suspicious traffic based on the groups for the number of data traffic.

15. A computer program product comprising:
a set of one or more computer-readable storage media;
program instructions stored in the set of one or more computer-readable storage media to perform operations comprising:
receiving, by a processor set, a number of traffic packets comprising TCP/IP packets from a number of sources;
determining, by the processor set, whether transmission for the number of traffic packets exceeds a pre-defined data transmission rate;
in response to determining that the transmission for the number of traffic packets exceeds the pre-defined data transmission rate, collecting, by the processor set, information associated with the number of traffic packets;
analyzing, by the processor set, a transport layer security (TLS) fingerprint associated with the number of traffic packets to determine whether combination of the transport layer security (TLS) fingerprint and TCP/IP address for the number of traffic packets is associated with a number of known issues; and
in response to determining that the combination of the transport layer security (TLS) fingerprint and the TCP/IP address for the number of traffic packets is associated with a number of known issues, blocking, by the processor set, data transmission for the number of traffic packets.

16. The computer program product of claim 15, wherein the operations further comprising:
in response to determining that the combination of the transport layer security (TLS) address and the TCP/IP address for the number of traffic packets is not associated with a number of known issues, analyzing, by the processor set, data associated with protocols and data format for the number of traffic packets;
determining, by the processor set, whether the data associated with protocols and data format for the number of traffic packets is related to a number of issues; and
in response to determining that the data associated with protocols and data format for the number of traffic packets is related to a number of issues, adding, by the processor set, the combination of the transport layer security (TLS) fingerprint and the TCP/IP address for the number of traffic packets to a first rate control table, wherein the first rate control table comprises a list of combinations of transport layer security (TLS) fingerprint and the TCP/IP address that are related to the number of issues.

17. The computer program product of claim 16, wherein the operations further comprising:
in response to determining that the data associated with protocols and data format for the number of traffic packets is not related to a number of issues, adding, by the processor set, the combination of the transport layer security (TLS) fingerprint and the TCP/IP address for the number of traffic packets to a second rate control table, wherein the second rate control table comprises a list of combinations of transport layer security (TLS) fingerprint and TCP address that are not related to the number of issues.

18. The computer program product of claim 15, wherein the information associated with the number of traffic packets comprises a cardinality metric for the combination of the transport layer security (TLS) fingerprint and the TCP/IP address, wherein the cardinality metric indicates a number of distinct HTTP/2 fingerprints.

19. The computer program product of claim 15, wherein the operations further comprising:
in response to determining that the number of traffic packets does not exceed the pre-defined data transmission rate, uploading, by the processor set, combination of the transport layer security (TLS) fingerprint, the TCP/IP address for the number of traffic packets, and HTTP/2 fingerprint for the transport layer security (TLS) fingerprint and the TCP/IP address for the number of traffic packets to a cardinality database to determine a cardinality metric associated with the combination of the transport layer security (TLS) fingerprint and the TCP/IP address for the number of traffic packets.

20. The computer program product of claim 15, wherein the operations further comprising:
collecting, by the processor set, metadata associated with a number of data traffic, wherein each data traffic from the number of data traffic comprises a number of data packets transmitted over a network;
clustering, by the processor set, the number of data traffic into groups based on traffic pattern determined from the metadata associated with the number of data traffic; and
identifying, by the processor set, the number of traffic data as suspicious traffic based on the groups for the number of data traffic.
